(19) United States
(12) Patent Application Publication
(10) Pub. No.: US 2004/0038716 A1
(43) Pub. Date: Feb. 26, 2004

(54) Hands free mobile phone communication system as well as a mobile terminal and an audio system therefore

(75) Inventor: Vincent Gass, Bolsenheim (FR)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/453,683

(22) Filed: Jun. 4, 2003

(30) Foreign Application Priority Data
Jun. 5, 2002 (EP) 02 360 162.8

(51) Int. Cl. H04B 7/15

(52) U.S. Cl. 455/569.1; 455/11.1

(57) ABSTRACT

The invention-relates to a hands free mobile phone communication system comprising a mobile terminal for receiving information over a telephone connection, with a radio sender for sending said information over a selected frequency channel to an audio system, the audio system being equipped with a broadcast radio receiver and with an audio amplifier for an audio output of information received on said selected frequency channel, wherein determination means to determine an unused frequency channel, communication means for communicating said information within the communication system and switching means to switch the radio sender and the radio receiver to said determined frequency channel are comprised, and a mobile terminal and an audio system therefore.

### BACKGROUND OF THE INVENTION

The invention is based on a priority application EP02360162.8 which is hereby incorporated by reference.

The invention relates to a hands free mobile phone communication system comprising a mobile terminal for receiving information over a telephone connection, with a radio sender for sending said information over a selected frequency channel to an audio system, the audio system being equipped with a broadcast radio receiver and with an audio amplifier for an audio output of information received on said selected frequency channel.

An increasing number of car owners have a mobile phone. For safely using a mobile phone or mobile terminal while driving, hands free operation of the mobile terminal is suggested. In a lot of countries, a speaker phone or a device for hands free communication is mandatory for the usage of a mobile terminal by a car driver. One problem for using a mobile terminal remote from the human ear in a car is the ambient noise, that makes it is difficult to understand a communication partner, even if the mobile terminal is switched to a maximum volume. To solve this problem, car kits are known from the prior art, that may be electrically connected or radio connected to the mobile terminal for amplification of the audio signal of the mobile terminal, and distribution over a corresponding acoustic system.

For coupling an existing car radio set including a radio data system (RDS) receiver to a mobile phone, EP 1047249 describes a system for hands free mobile communication in a car with a mobile terminal comprising an FM (frequency modulation) emitter including an RDS emitter. When a call is coming in to the mobile terminal, said mobile terminal sends an RDS information to the radio set to advise said radio set to receive FM-modulated information of a certain carrier frequency from the mobile terminal. The FM receiver of the radio set then switches to the advised frequency and the audio output of the car radio is switched to said FM-receiver for distributing the received information to the loudspeakers connected.

For this system, at least one more or less permanent blank frequency, i.e. an unused frequency band or frequency channel, must be known in advance to be used for the diffusion of said FM signals by the mobile terminal. However, in a lot of regions in the world, blank frequencies are quite rare. Moreover, in countries with a dense distribution of radio senders and a difficult topography (mountains), the distribution of black frequencies is depending on the reception situation of different radio senders of the receivers location. Thus, for a moving car, available blank frequencies, i.e. unused or not occupied frequencies, may change quite often.

### SUMMARY OF THE INVENTION

The object of the invention is to propose a method, a terminal and a communications system in the context of the above described system, that allows a continuous diffusion of said radio signals over dynamically changing unused frequency channels.

The basic principle of the invention is, that unused frequency channels are continuously determined, i.e. by carrying out periodically frequency scanning runs, in a hands free communication system comprising a mobile terminal and an audio system, equipped with a radio sender and a radio receiver respectively. The mobile terminal and the audio system actually communicate a selection of a free frequency channel and each synchronise to said selected free frequency.

Further developments of the invention can be gathered from the dependent claims and the following description.

### BRIEF DESCRIPTION OF THE DRAWINGS

In the following the invention will be explained further making reference to the attached drawings in which:

FIG. 1 schematically shows an exemplary embodiment of a hands free mobile phone communication system according to the invention,

FIG. 2 schematically shows an exemplary further embodiment of the hands free mobile phone communication system according to FIG. 1 and

FIG. 3 shows a base band spectrum of a standard FM broadcast signal with stereo and sub carrier signals.

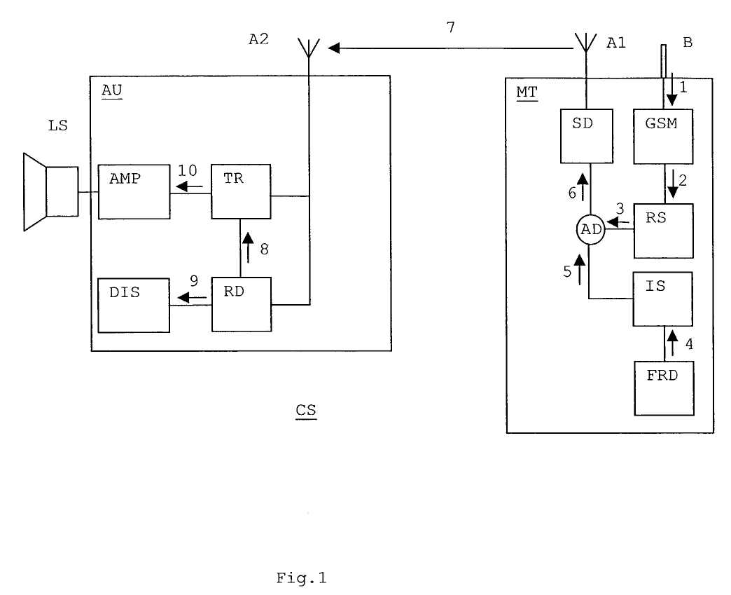

FIG. 1 schematically shows a hands free mobile phone communication system CS comprising an audio system AU and a mobile terminal MT. The break down of functional blocks explained in the following is shown in principle and does not claim completeness. Particularly, preamplifiers or attenuators, that might be necessary to adapt the signal power are not shown here. The shown functional blocks might be realised as distinctive physical devices or as logical blocks, i.e. as a program module, within one microprocessor controlled physical device, e.g. the mobile phone MT or the audio system AU. Said blocks might be combined or further divided into sub block or functions of one block might be shifted to another block without leaving the scope of the invention. The audio system AU comprises an FM receiving antenna A2, an FM (FM=frequency modulation) tuner TR and a RDS decoder RD an audio amplifier AMP and a display DIS. The FM receiving antenna A2 is connected to the inputs of each the FM tuner TR and to the RDS decoder RD. The output of the RDS decoder RD is connected to the input of the display DIS. The output of the FM tuner TR is connected to the input of the amplifier AMP, that is connected at its output to a loudspeaker LS, here shown by way of example as an external device.

The mobile terminal MT shows an GSM antenna B, an FM sending antenna A1, a GSM receiver GSM, an FM signal generator RS, an RDS encoder RE, a frequency scanner FRS an FM sender SD and a signal adder AD. The GSM antenna B is connected to the input of the GSM receiver GSM. The output of the GSM receiver is connected to the input of the FM signal generator RS. The output of the frequency scanner FRS is connected to the RDS encoder RE. The outputs of each the FM signal generator RS and the RDS encoder RE are connected to the signal adder AD with its output connected to the input of the FM sender SD. The output of the FM sender SD is connected to the FM sending antenna A1.

In the following a rough logical information/signal flow will be explained:

A GSM signal 1 is received at the GSM antenna B and forwarded to the GSM receiver GSM. The GSM receiver decodes said GSM data 1 and passes respective decoded GSM data 2 to the FM signal generator RS said signal generator generates a modulated base band FM signal 3 according to FIG. 3 explained later on. The frequency scanner FRS periodically scans the FM frequency band, i.e. the frequency band between 87 MHz and 107 MHz for free frequency channels. If a free channel is detected, the detected free channel, or, if more than one free channel is detected, a selected one of the detected free frequency channels is reported as free frequency or free channel information 4 to the RDS encoder RE. The RDS encoder encodes said frequency or channel information generating a corresponding RDS signal 5 modulated on the RDS sub carrier at 57 KHz. Said RDS signal 5 and the FM signal 3 are combined by the signal adder AD and a corresponding combined signal 6 is fed to the FM sender SD. The FM sender shifts the spectrum of said combined signal 6 into the selected free frequency channel generating an FM signal 7 to be emitted over the at a frequency corresponding to the sending antenna A1. This signal is received by the receiving antenna A2 and fed to the FM tuner TR and the RDS decoder RD. The RDS decoder RD, by decoding the RDS signal part of the FM signal 7 retrieves the channel information 4 generated by the frequency scanner FRS. Said channel information and or other information comprising in the RDS signal can be fed as display data 9 to the display DIS. Based on said channel information, the tuner TR is advised by advising information 8 to switch to the corresponding frequency for demodulating the received FM signal 7. The demodulated FM signal 10 is fed to the amplifier AMP, that outputs corresponding audio data to the loudspeaker LS.

The above solution does not require any change on existing car radios capable of receiving RDS information to serve as an audio system AU. Existing mobile phones can be easily modified to serve as mobile terminal MT by adding a radio emitter card as an accessory, which uses the same wiring as the already existing radio receiver card for mobile terminals.

When the mobile terminal MT receives a call, an RDS code named TA (Traffic Announcement) is first sent to the audio system AU to automatically switch to the radio (if not already being switched to). The same code TA is used to carry the advising information 8 to command the radio to switch on a selected frequency, i.e. a frequency, that was selected by the frequency scanner FRS. The ringing tone now is transmitted over FM radio to the loudspeaker LS. Moreover, the RDS information may contain additional information, e.g. the GSM caller name or the calling number to be displayed on the display DIS. The GSM conversation then (if the called user accepts) is transmitted between the mobile terminal MT and the audio system AU on the selected FM frequency. If, during moving, the free frequencies change, i.e. if occupation is detected on the currently used frequency, the frequency scanner FRS selects a new frequency and initiates sending an RDS information to the audio unit AU to switch (in a certain, e.g. predefined time) to said selected frequency. The transmission frequency between the mobile terminal MT and the audio system is changed to the selected frequency or channel.

Alternatively to the display of RDS information, said information is converted into audio information. For this case conversion means are comprised in the audio system to convert RDS information received by the mobile terminal MT, MT′ into speech information to be fed to the amplifier AMP.

Alternatively to the frequency scanning in the mobile terminal MT, the frequency scanning is performed within the audio system AU, that informs the mobile terminal MT about a selected free frequency.

Alternatively to the radio transmission between the audio system AU and the mobile terminal MT, the communication is performed over an antenna wire. In this case, proprietary coded information can be easily additionally transmitted. So, free channel information may be sent from the radio to the mobile phone or vice versa by proprietary protocols.

A mobile terminal MT can be used together with audio systems of different cars. Providing a method to send an identification code, i.e. the GSM SIM (subscriber information module) authentication code to the audio system AU, that may identify the corresponding user. In this way, an easy anti theft feature may be realised: Without correct identification data, the car radio remains switched off.

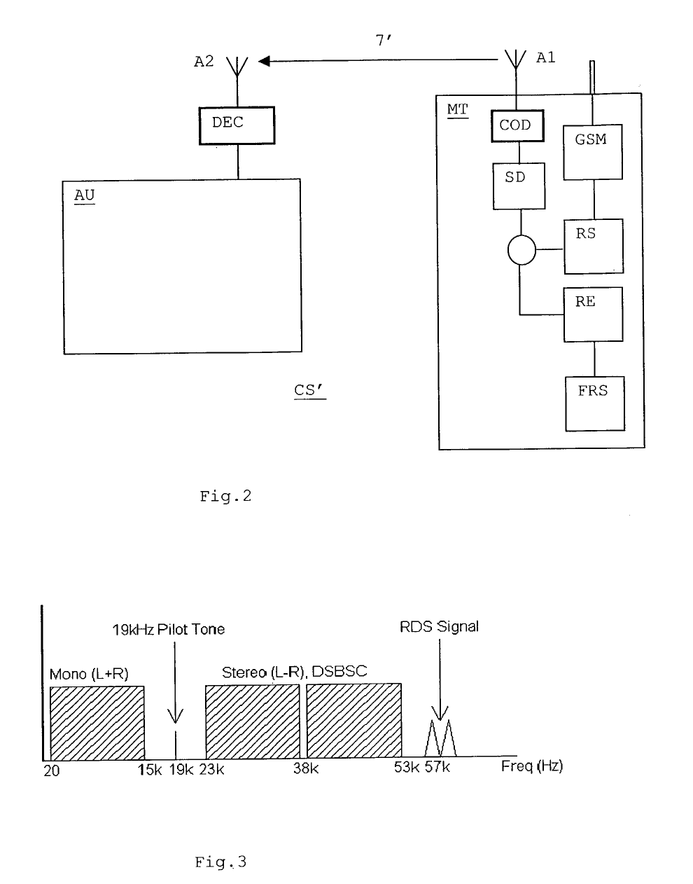

FIG. 2 shows an exemplary further embodiment of the previously described hands free mobile phone communication system, that enables a high level of confidentiality for the communication between the mobile terminal MT and the audio system AU. FIG. 2 shows, in addition to FIG. 1 a modified hands free mobile phone communication system CS′ with a small decoder DEC, that is connected to the antenna plug of the audio system AU, i.e. between the FM receiving antenna A2 and the audio system AU. A corresponding coding device COD is shown inserted between the FM sender SD and the FM sending antenna A1 of a modified mobile terminal MT′. Between the modified mobile terminal MT′ and the audio system AU, a coded FM signal 7′ is transmitted. If this FM signal is intercepted by other FM receivers, e.g. by car radios of adjacent cars, the information carried in this signal 7′ can not be decoded without knowing the corresponding coding key.

Today, CSM terminal equipped with MP3 players are available. The proposed solution can be used to play MP3 files from the mobile terminal MT or MT′ via the car audio system, still keeping the basic service (GSM telephony) available.

If localisation services are available within a corresponding GSM system, the proposed solution makes it possible to display the related information on the car radio display.

The RDS system is a standardised and well known system in Europe for transmitting data together with frequency modulated (FM) voice information. The RDS uses an own sub carrier of a frequency of 57 KHz in the base band.

Referring to FIG. 3, a well known spectrum of an FM base band signal including an RDS signal spectrum is shown. A first band Mono, carrying a left signal and right signal (L+R), covers the range between 20 Hz and 15 KHz and a second band stereo (with both side bands), carrying the left signal minus the right signal (L-R), covers the range between 23 KHz and 53 KHz. A pilot tone carrier at 19 KHz serves to decode and to provide a stereo difference signal. Around a sub carrier at 57 KHz, which is used to separate left and right channels in a receiver. Further, +/−2.4 KHz around an RDS sub carrier at 57 KHz, left and right parts of an RDS data signal are shown (exhibiting low energy around the sub carrier frequency of 57 KHz). The RDS signal is decoded in the receiver e.g. to provide display information or control information as described under the figures FIG. 1 and FIG. 2.

Instead of FM modulation, other kind of signal modulation may be used for signal transmission between the mobile terminal MT and the audio system. Instead of RDS coded information, any other kinds if data signal may be sent between the mobile terminal MT and the audio system.

1. A hands free mobile phone communication system comprising a mobile terminal for receiving information over a telephone connection, with a radio sender for sending said information over a selected frequency channel to an audio system, the audio system being equipped with a broadcast radio receiver and with an audio amplifier for an audio output of information received on said selected frequency channel, wherein determination means for determining an unused frequency channel, communication means for communicating said information within the communication system and switching means for switching the radio sender and the radio receiver to said determined frequency channel are comprised.

2. A hands free mobile phone communication system according to claim 1, wherein coding means are comprised for modification of the information to be sent to said audio system and decoding means are comprised to eliminate said modification before an audio output.

3. A hands free mobile phone communication system according to claim 1, wherein identification means in the audio system for an identification of the mobile phone and locking means for electrically locking said audio system depending on the identification result are comprised.

4. A hands free mobile phone communication system according to claim 1, wherein conversion means are comprised to convert signalling information received by the mobile terminal into speech information for audio distribution of the audio system.

5. A mobile terminal for receiving telephone information over a telephone connection, with a radio sender for sending corresponding information over a selected frequency channel to be received by an audio system equipped with a broadcast radio receiver wherein the mobile terminal comprises selection means to determine an unused frequency channel and generating means for generating a corresponding request to be received by said audio system.

6. An audio system comprising a broadcast radio receiver to receive information on a selected frequency channel, wherein identification means for an identification of a sending mobile phone and locking means for electrically locking said audio system depending on the identification result are comprised.
